(19) United States
(12) Patent Application Publication
(10) Pub. No.: US 2012/0001931 A1
(43) Pub. Date: Jan. 5, 2012

(54) ADJUSTING SYSTEM, METHOD AND PROJECTOR INCLUDING THE SAME

(75) Inventor: Ming-Chih HSIEH, Tu-Cheng (TW)

(73) Assignee: HON HAI PRECISION INDUSTRY CO., LTD., Tu-Cheng (TW)

(21) Appl. No.: 12/848,102

(22) Filed: Jul. 31, 2010

(30) Foreign Application Priority Data
Jul. 2, 2010 (TW) 99121948

(51) Int. Cl. G09G 5/00; G06K 9/40

(52) U.S. Cl. 345/581; 345/520; 382/267; 348/E09.025

(57) ABSTRACT

A projector includes a body, an input unit for receiving images, a reference image storage unit for storing a reference image, a micro controller unit (MCU), a graphic processing unit (GPU), an optical unit, and a sensing unit. The reference image is processed by the MCU and the GPU, and then projected on a screen to form a projection image by the optical unit. The sensing unit is mounted on a front surface of the body to sense the projection image and transmit data of the projection image to the MCU. The MCU compares the reference image and the projection image to obtain a correction value. The GPU adjusts its calculations according to the correction value.

### BACKGROUND

1. Technical Field

The present disclosure relates to projectors, and particularly, to a projector including an adjusting system, and an adjusting method for the projector.

2. Description of Related Art

Projectors are widely used in a lot of places, such as offices, homes, etc. Sometimes, users need manually adjust the projection angle of a projector, to make the projected image align with the screen. However, when the projection angle is raised past a certain angle, the image on the screen may become distorted and appear as a trapezoid shape. Furthermore, the image projected by a lens may experience color distortions. As a result, the image parameters need to be adjusted in the menu of the projector or by pressing other buttons on the projector, which is inconvenient and time-consuming.

### BRIEF DESCRIPTION OF THE DRAWINGS

FIG. 1 is an isometric view of an exemplary embodiment of a projector.

FIG. 2 is a block diagram of the projector of FIG. 1.

FIG. 3 is a schematic diagram of a reference image.

FIGS. 4A and 4B are a flowchart of an exemplary embodiment of an adjusting method.

FIG. 5 is a schematic diagram of rims of a first projection image and a second projection image.

### DETAILED DESCRIPTION

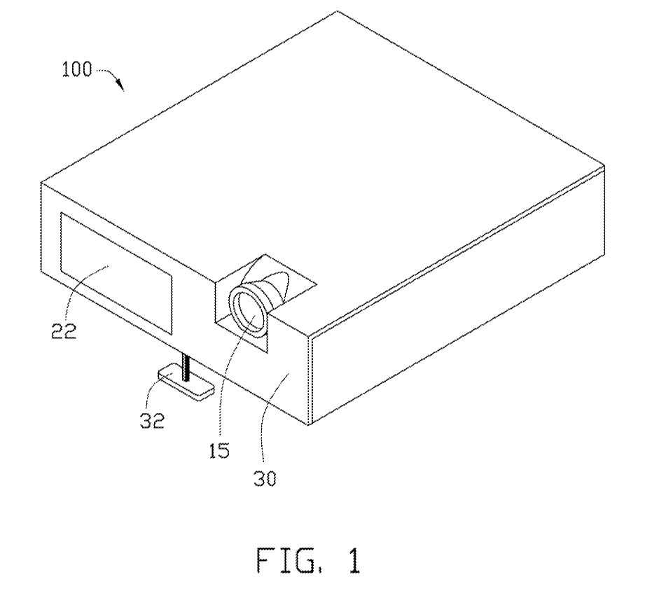

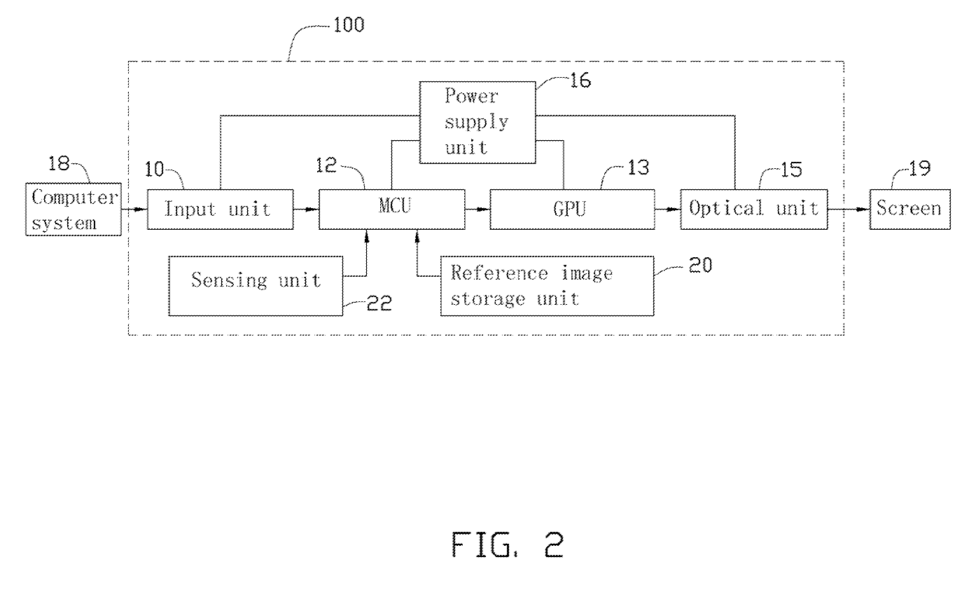

Referring to FIGS. 1 and 2, an embodiment of a projector 100 includes a body 30, an elevation shaft 32, an input unit 10, a micro controller unit (MCU) 12, a graphics processing unit (GPU) 13, an optical unit 15, a reference image storage unit 20, a sensing unit 22, and a power supply unit 16. The MCU 12, the reference image storage unit 20, and the sensing unit 22 compose an adjusting system for the projector 100.

In the embodiment, the input unit 10, the MCU 12, the GPU 13, the optical unit 15, the reference image storage unit 20, and the power supply unit 16 are located inside of the body 30 of the projector 100. The sensing unit 20 mounts on a front surface of the body 30.

In use, the user connects a computer system 18 to the input unit 10 of the projector 100, for transmitting images stored in the computer system 18 to the projector 100. The images are processed by the MCU 12 and the GPU 13, and then projected on a screen 19 by the optical unit 15. The power supply unit 16 provides power for the MCU 12, the GPU 13, and the sensing unit 20. In addition, the projector 100 can include other units, such as a heat dissipation unit.

The reference image storage unit 20 stores a reference image. When the projector 100 is powered on and the projection angle of the projector 100 is 0 degrees, the projector 100 projects the reference image on the screen 19 to form a first projection image on the screen 19. When the projection angle of the projector 100 is raised up to a certain angle, the projector 100 projects the reference image on the screen 19 to form a second projection image on the screen 19.

The sensing unit 22 is a complementary metal oxide semiconductor (CMOS) sensor to sense the first and second projection images on the screen 19. The MCU 12 compares the reference image, the first and second projection images to obtain a correction value according to the comparison result. The GPU 13 compensates for distortion in the projected image according to the correction value. In the embodiment, the GPU 13 may adjust its calculations to compensate for distortion in the projected image.

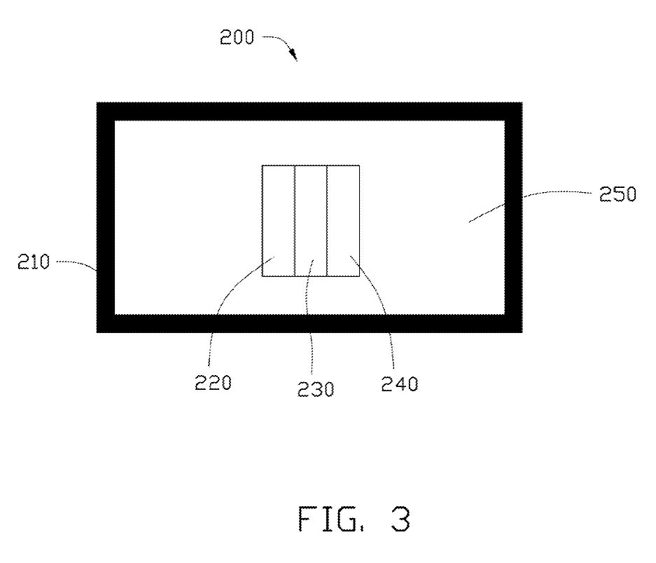

Referring to FIG. 3, the reference image 200 includes a black border 210, a red strip 220, a green strip 230, a blue strip 240, and a white region 250 in the border 210.

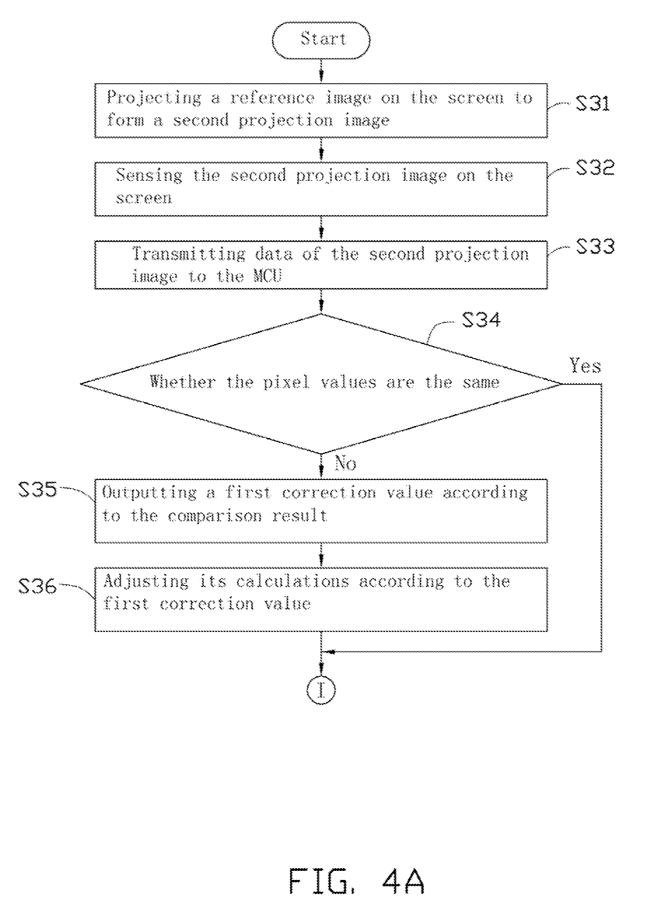

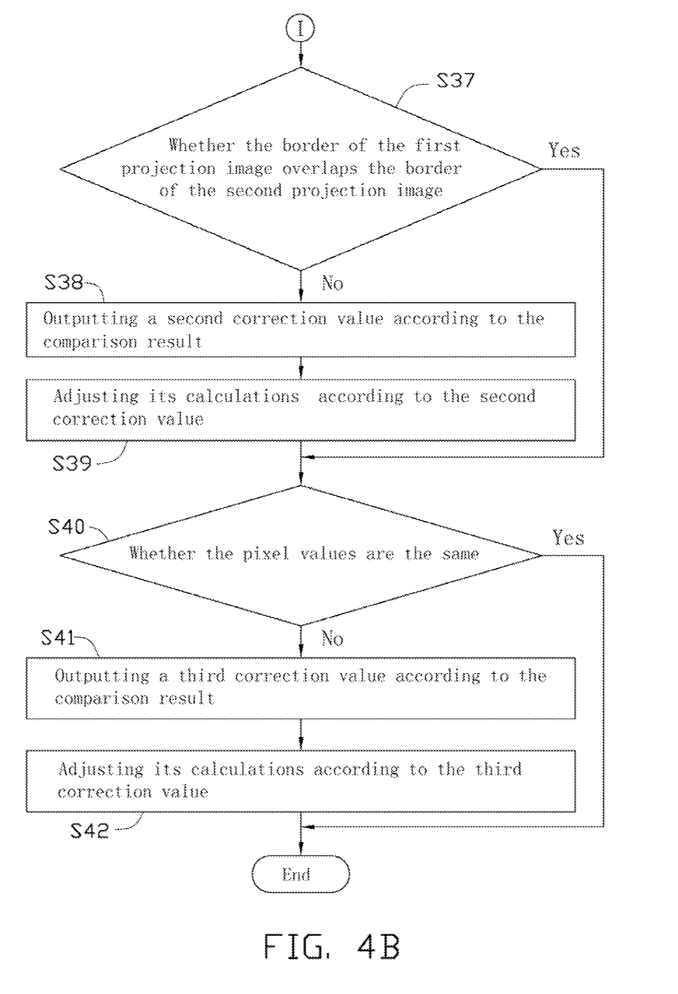

Referring to FIGS. 4A and 4B, an embodiment of an adjusting method for the projector 100 includes the following steps.

In step S31, the reference image 200 is projected on the screen 19 to form the second projection image.

In step S32, the sensing unit 22 senses the second projection image on the screen 19.

In step S33, the sensing unit 22 transmits data of the second projection image to the MCU 12.

In step S34, the MCU 12 compares the pixel values of the red strip 220, the green strip 230, and the blue strip 240 in the reference image 200 with the pixel values of the corresponding portion in the second projection image respectively. If the pixel values of the portions in the two images are the same, it represents that the projector 100 does not need a red-green-blue (RGB) adjustment, and the step S37 is executed. If the pixel values of the portions in the two images are not the same, the step S35 is executed.

In step S35, the MCU 12 outputs a first correction value according to the comparison result.

In step S36, the GPU 13 compensates for distortion in the projected image according to the first correction value. The RGB adjustment is completed. After the RGB adjustment has been completed, the GPU 13 processes the images from the input unit 10 according to the adjusted calculations.

To obtain the first correction value, will be described as follows. For example, if the pixel value of the red strip 220 in the reference image 200 is “F50000”, and the pixel value of the corresponding portion in the second projection image is “F10000”, the MCU 12 obtains the first correction value according to the difference between the pixel values “F50000” and “F10000”. The GPU 13 amends the pixel value of the red strip 220 in the reference image 200 from “F50000” to “F90000”. As a result, the pixel value of the corresponding portion in the second projection image on the screen 19 is “F50000”.

In step S37 (FIG. 4B), the MCU 12 compares the rim of the first projection image with the rim of the second projection image to determine whether the two rims overlap. If the two rims overlap, it represents that the projector 100 does not need a trapezium adjustment, and the step S40 is executed. If the two rims do not overlap, the step S38 is executed.

In step S38, the MCU 12 outputs a second correction value according to the comparison result.

In step S39, the GPU 13 compensates for distortion in the projected image according to the second correction value. The trapezium adjustment is completed. After the trapezium adjustment has been completed, the GPU 13 processes the images from the input unit 10 according to the adjusted calculations.

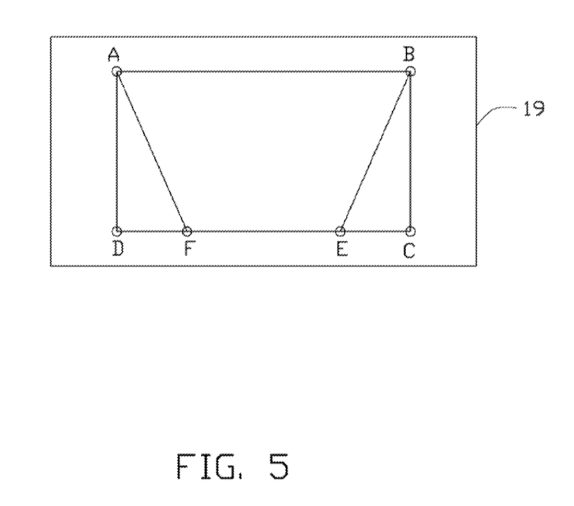

To obtain the second correction value, will be described as follows. For example, referring to FIG. 5, the rim of the first projection image is shown as ABCD, and the rim of the second projection image is shown as ABEF. The MCU 12 obtains the second correction value according to an angle between the lines AF and AD and an angle between the lines BC and BE. The GPU 13 extends the length of the bottom side in the border 210 in the reference image 200 correspondingly. As a result, when the projection angle of the projector 100 is raised up to the certain angle, the reference image 200 is projected on the screen 19 to form a rectangle.

In step S40, the MCU 12 compares the pixel values of the border 210 and the white region 250 of the reference image 200 with the pixel values of the corresponding portions in the second projection image respectively, to determine whether the pixel values are the same. If the pixel values are the same, it represents that the projector 100 does not need a black and white adjustment, and the process ends. If the pixel values are not the same, the step S41 is executed.

In step S41, the MCU 12 outputs a third correction value according to the comparison result.

In step S42, the GPU 13 compensates for distortion in the projected image according to the third correction value. The black and white adjustment is completed. After the black and white adjustment has been completed, the GPU 13 processes the images from the input unit 10 according to the adjusted calculations.

How to obtain the third correct value will be described as follow. For example, if the pixel value of the white region 250 in the reference image 200 is “FFFFFA”, and the pixel value of the corresponding portion in the projection image is “FFFFF8”, the MCU 12 obtains the third correct value according to the difference between the pixel values “FFFFFA” and “FFFFF8”. The GPU 13 amends the pixel value of the white region 250 in the reference image 200 from “FFFFFA” to “FFFFFC”. As a result, the pixel value of the corresponding portion in the projection image on the screen 19 is “FFFFFA”.

After the RGB adjustment, the trapezium adjustment, and the black and white adjustment have been completed; the GPU 13 processes the images from the input unit 10 according to its arithmetic. The processed images are projected on the screen 19, and the projected images are not distorted. It can be understood that in other embodiments, one or more of the following RGB adjustments, the trapezium adjustments, and/or the black and white adjustments may be executed.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. An adjusting system for a projector, the adjusting system comprising:
a reference image storage unit, for storing a reference image, wherein the reference image is projected on a screen to form a projection image;
a sensing unit mounted on a front surface of a body of the projector, for sensing the projection image on the screen; and
a micro controller unit (MCU) for comparing the reference image and the projection image to obtain a correction value; wherein the correction value is transmitted to a graphics processing unit (GPU), the GPU adjusts its calculations according to the correction value.

2. The adjusting system of claim 1, wherein the MCU compares pixel values of a red portion, a green portion, and a blue portion in the reference image with corresponding portions in the projection image to obtain the correction value.

3. The adjusting system of claim 1, wherein the reference image comprises a rectangular border the projection image comprises a first projection image and a second projection image; wherein when the projector is horizontal, the reference image is projected on the screen to form the first projection image, when the projector is raised to a certain angle from the horizontal, the reference image is projected on the screen to form the second projection image; the MCU compares the borders of the first and second projection images to obtain the correction value.

4. The adjusting system of claim 1, wherein the MCU compares pixel values of a black portion and a white portion in the reference image with pixel values of corresponding portion in the projection image to obtain the correction value.

5. The adjusting system of claim 1, wherein the reference image comprises a black rectangle border, a red strip, a green strip, a blue strip, and a white region.

6. A projector comprising:
a body;
an input unit for receiving images;
a reference image storage unit for storing a reference image;
a micro controller unit (MCU);
a graphic processing unit (GPU);
an optical unit, wherein the reference image is processed by the MCU and the GPU, and then projected on a screen to form a projection image by the optical unit; and
a sensing unit mounted on a front surface of the body, for sensing the projection image and transmitting data of the projection image to the MCU, wherein the MCU compares the reference image and the projection image to obtain a correction value, the GPU adjusts its calculations according to the correction value.

7. The projector of claim 6, wherein the MCU compares pixel values of a red portion, a green portion, and a blue portion in the reference image with corresponding portions in the projection image to obtain the correction value.

8. The projector of claim 6, wherein the reference image comprises a rectangle border, the projection image comprises a first projection image and a second projection image; wherein when the projector is horizontal, the reference image is projected on the screen to form the first projection image, when the projection angle of the projector is raised to a certain angle from the horizontal, the reference image is projected on the screen to form the second projection image; the MCU compares the rims of the first and second projection images to obtain the correction value.

9. The projector of claim 6, wherein the MCU compares pixel values of a black portion and a white portion in the reference image with pixel values of corresponding portion in the projection image to obtain the correction value.

10. The projector of claim 6, wherein the reference image comprises a black rectangle border, a red strip, a green strip, a blue strip, and a white region.

11. An adjusting method for a projector, the adjusting method comprising:
projecting a reference image on a screen to form a projection image;
sensing the projection image;
transmitting data of the projection image to a micro controller unit (MCU);
comparing the reference image and the projection image to obtain a correction value; and
adjusting calculations of a graphic processing unit (GPU) according to the correction value.

12. The adjusting method of claim 11, wherein the step “comparing the reference image and the projection image to obtain a correction value” comprises:
comparing pixel values of a red portion, a green portion, and a blue portion in the reference image with corresponding portions in the projection image to obtain the first correction value.

13. The adjusting method of claim 11, wherein the reference image comprises a rectangle border, the projection image comprises a first projection image and a second projection image, when a projection angle of the projector is 0 degrees, the reference image is projected on the screen to form the first projection image, when the projection angle of the projector is raised to a certain angle, the reference image is projected on the screen to form the second projection image; wherein the step “comparing the reference image and the projection image to obtain a correction value” comprises:
comparing the rims of the first and second projection images to obtain the correction value.

14. The adjusting method of claim 11, wherein the step “comparing the reference image and the projection image to obtain a correction value” comprises:
comparing pixel values of a black portion and a white portion in the reference image with pixel values of corresponding portion in the projection image to obtain the correction value.
